(19) United States
(12) Patent Application Publication
(10) Pub. No.: US 2010/0125646 A1
(43) Pub. Date: May 20, 2010

(54) System For Enabling Host-Independent Software Portability Of A Self-Contained Device

(75) Inventors: Dror Wettenstein, Ornit (IL); Dror Sofer, Tel Aviv (IL); Dror Gill, Haifa (IL)

Correspondence Address: Fleit Gibbons Gutman Bongini & Bianco PL, 21355 EAST DIXIE HIGHWAY, SUITE 115, MIAMI, FL, 33180, US

(73) Assignee: CEEDO TECHNOLOGIES (2005) LTD, Petach Tikva (IL)

(21) Appl. No.: 11/993,672

(22) PCT Filed: Sep. 26, 2006
(86) PCT No.: PCT/IL2006/001126

§ 371 Date: Feb. 1, 2010

Related U.S. Application Data
(60) Provisional application No. 60/720,562, filed on Sep. 27, 2005.
(60) Provisional application No. 60/720,561, filed on Sep. 27, 2005.

(51) Int. Cl. G06F 15/16

(52) U.S. Cl. 709/219; 709/217

(57) ABSTRACT

A system and method that enable placing on an active PMD host software that normally requires installation on a host, and running such software on a host connected to the PMD, without installing the software on the host. In this way, the PMD becomes self-contained, and can connect to any host for the purpose of interaction, manipulation and transfer of content stored on the PMD, without requiring any proprietary software related to the PMD to be pre-installed on the host, and without installing any software on the host during the connection of the PMD to the host.

### FIELD OF THE INVENTION

The present invention relates to Personal Mobile Devices (PMDs) such as mobile phones, and more specifically to the implementation of software which runs on a Host system such as a personal computer (PC) and which interacts with content stored on a PMD.

### GLOSSARY

### CD—Compact Disc

### DLL—Dynamic Link Library

### DSL—Digital Subscriber Line

### GPRS—General Packet Radio System

### IEEE—Institution of Electrical and Electronic Engineers

### LAN—Local Area Network

### MMS—Multimedia Messaging Service

### MP3—MPEG-1 Layer 3

### MPEG—Motion Pictures Expert Group

### PDA—Personal Digital Assistant

### PC—Personal Computer

### RAM—Random Access Memory

### SMS—Short Messaging Service

### STB—Set-Top Box

### USB—Universal Serial Bus

### UWB—Ultra-Wide Band

### TV—Television

### BACKGROUND OF THE INVENTION

The past few years have witnessed a proliferation of PMDs, which are used for communication, information access and management, entertainment and media creation. Devices such as digital music players, digital still cameras, and most notably mobile phones, are being used by a large portion of the population and serve a variety of tasks. For example, in 2006, annual worldwide sales of cellular phones are expected to reach 930 million units, and market penetration in developed countries will exceed 90%.

The cellular phone, which has been used traditionally for voice communication, has recently evolved into an integrated PMD, which is also used for a plethora of data services. These include mobile web browsing, SMS and MMS messaging, downloading of images, ring tones, music files and video clips, and self-generation of multimedia content through the inclusion of still image and video cameras. In addition to the cellular phone, there exists a variety of other PMDs. These include Personal Digital Assistants (PDAs), mobile audio and video players (MP3 players and Portable Media Players), personal navigation devices, digital still cameras and digital video cameras, which enable a more dedicated implementation of some of the functionality embedded in an integrated mobile handset.

All of the PMDs described above require some interaction with a Host device, such as a PC. The interaction is required since the Host typically has a larger display, more convenient input method (e.g. keyboard and mouse), larger storage capacity and a higher-speed network connection. Another reason for interaction is that PMDs create and receive content when they are detached from the Host, by capturing the content with the device's camera, microphone, stylus, keypad or keyboard, or by receiving the content over a wireless connection such as a cellular or wireless LAN network. Viewing, manipulating, editing and storing the content in a more convenient way than possible on the PMD itself requires interaction with a Host computer, and running Host applications on the Host.

Typical interaction methods between the PMD and the Host include backup of the data on the PMD to protect the data in cases where the PMD is lost or stolen; writing and reading messages (SMS, MMS and email) in a more convenient mariner; editing, storage, printing and publishing of media data captured with the PMD (such as still pictures and video clips); purchase, download and organizing of music and video data for the PMD; and synchronizing the content of the PMD and the Host (such as contacts, tasks, web bookmarks, files, etc.) to enable the user to seamlessly access such data both on the PMD and on the Host.

In order to enable such interaction between a Host and a PMD, proprietary software needs to be pre-installed on the Host. For this purpose, most PMDs are sold with a CD which contains such proprietary software. The user is required to install the software on the Host, prior to connecting the PMD to the Host, to enable the interaction between the PMD and the Host. In other cases, the proprietary software for interacting with the PMD is downloaded by the user over the Internet from the website of the device vendor, and is installed on the Host. The drawback of both methods is that the user has to be technically knowledgeable to a level that enables installing software on the Host, and solving problems that may come up during such installation, such as driver conflicts, software library (DLL) conflicts, incorrect operating system support, etc.

Note that some PMDs, such as flash memory USB devices and some models of digital still cameras are automatically identified by some advanced Host operating systems (for example, Microsoft Windows Plug & Play), and enable some form of simple interaction with the device without installing any proprietary software. However, such interaction methods are limited to very basic operations such as file transfer to/from the device and elementary editing such as picture rotation. The “Plug & Play” method does not enable advanced interaction methods such as user-controlled backup, synchronization, automatic launch of image editing and management software, direct access and control over mobile device applications such as sending SMS or MMS, and initiating a data connectivity session such as a cellular modem. In addition, such methods do not support all of the PMDs on the market, and especially newly released devices and complex devices such as smart phones which require a high level of interaction between their internal data and media content and the Host.

U.S. Patent application 2005/0240918 by Gteko Ltd. describes a method for executing software applications using a portable device. However, application 2005/0240918 refers only to a portable memory device, which is a passive device that cannot change its own content when detached from the Host. In addition, the method described in application 2005/0240918 has been implemented in products that have been available on the market for the past several years, from companies such as Migo Software (formerly PowerHouse Technologies), 555 Twin Dolphin Drive, Suite 650, Redwood City, Calif. 94065 USA and ThinStall, 22 Battery Street, Suite 703, San Francisco, Calif. 94111 USA, Furthermore, the application portability enabled by US patent Application 2005/0240918 and the commercial products from Migo Software and ThinStall is performed separately for each Host software application, so the Host applications do not form a full virtual working environment on the Host. Therefore, if one application that resides on the portable memory device launches a second application, the second application is launched from the Host and not from the portable memory device.

### SUMMARY OF THE INVENTION

The present invention describes a system and method which overcomes the drawbacks of existing methods for interaction between a Host device and a PMD. This is achieved by storing the Host software, which is required to support such interaction, on the PMD itself; and launching the software on the Host when the PMD is connected to the Host. Using the method described in this invention, the Host software runs directly from the embedded non-volatile memory of the PMD, without requiring any installation or configuration of the Host. Therefore, the user can connect the PMD to any Host (not only a single Host that has pre-installed proprietary software), and enjoy the advanced interaction methods enabled by the Host using the self-contained PC software stored on the PMD itself. Furthermore, such interaction methods can be applied to content created or received by the PMD itself when detached from the Host, content which can not be conveniently manipulated on the PMD itself. For example, using the present invention, the user can carry on his/her PMD interaction software such as backup and synchronization software, SMS and MMS editors, image and video viewing and editing software, music playback software, etc. Thus, the PMD of the present invention is an “active” device in the sense that it can create and receive content while disconnected from a Host, while a portable memory device cannot do this.

As used herein, the term “Host software” includes two types: “installable” Host software that makes use of host system resources such as DLLs (Dynamic Link Libraries), system folders, and systems settings database (the Registry in Microsoft Windows operating systems), and therefore requires a process of installation on the host prior to being able to execute on the host; and “non-installable” Host software that does not use any host system resources and can execute on the host without performing an installation process.

Advantageously, in addition to enabling the user to carry on their PMD the Host software which is required for interaction with the PMD, the present invention also enables the user to carry any other Host software on his/her PMD, creating a mobile PC environment which is available to the user whenever he/she plugs his/her PMD into any PC. Such Host software may include Voice over IP (VOIP) software such as Skype, Instant Messaging software such as Yahoo Messenger or MSN Messenger, web browser software, email software, or any other software which the user has the need to access when mobile.

Further advantageously, in addition to enabling the user to carry full Host applications on his/her PMD, the present invention also enables the user to carry settings and parameters which are used by Host software residing on the Host, when the PMD is connected to the Host (“Profiled Applications”). Such parameters may include account settings and contact lists for email, instant messaging and VoIP software; bookmarks, toolbars and other settings for web browsers; templates, styles, personal dictionaries, and other settings for personal productivity applications; and any other personal settings and preferences which are stored in the PMD and used by Host software applications residing on the Host.

Another advantage of the present invention is that the Host software contained in the PMD is automatically updated through the Internet when the device is connected to the Host. Therefore, the Host software is always up to date, and does not require manual downloading of updates by the user.

A further advantage of the present invention is that the Host software contained in the PMD can download additional content to the PMD from a server that resides on the Internet, such as ringtones, screen savers, games, music and video files, etc. This enables fast and cheap content transfer from the Internet to the PMD, compared to downloading such content directly over the cellular network.

Yet another advantage of the present invention is that the Host software contained in the PMD creates a virtual environment when running on the Host, which enables software applications to interact with each other. For example, when a Host software mail program is launched from the PMD, and an email is received which contains an attachment of a media file, clicking on the media file will result in launching the media player Host software that resides on the PMD, and not the default media player that resides on the Host.

The present invention offers several advantages to users, manufacturers and providers of services to PMDs such as cellular operators.

### End-User Advantages

No need to download software from the Internet to support the PMD.
No need to manually install software on the Host (e.g. PC) to enable the Host to interact with the PMD
The ability to connect the PMD to any Host device (not just the user's own PC) and enjoy the rich interaction features enabled by the Host software embedded in the device. This enables connecting the PMD to personal computers of friends and family, home and office, and also Internet café and campus PC farms without installing any software on the personal computer.
Eliminating the need to carry around a laptop PC in many cases, by placing the user's personal PC environment, including both data files, personalized PC applications and PMD-related PC applications, on the flash memory embedded in a PMD.

### Device Vendor Advantages

No need to provide a software installation CD together with the PMD to the end user.
The Host software for interacting with the PMD is not static as in the case of a CD, but automatically updates itself over the Internet when the mobile device is connected to the Host.
The ability to create a truly mobile device that can use not just its internal embedded software but also the more sophisticated Host software for interacting with and manipulating the device content anywhere.
Higher percentage of users which will use the Host interaction features of the PMD and therefore will utilize the device to a fuller extent.

### Service Provider Advantages

Ease of use for the service provider's customers, resulting in fewer calls to the customer support center and reduced costs.
The ability to create a link between the web presence of the service provider and the PMD, to enable users to access and purchase content, new devices and new services through the Host software which is embedded inside the PMD.

According to the present invention there is provided a system for enabling host-independent software portability including a host capable of executing host software and an active PMD capable of creating and receiving content while disconnected from the host and capable of running the host software on the host when connected to the host, whereby the host software is launched automatically on any host upon connection of the PMD to that host.

In some embodiments, the system further includes a server operatively coupled to the host and the PMD and capable of storing host software updates and PMD content for use in exchanges with the host and the PMD respectively.

Inventively, the host software includes a virtual host environment (VHE) executable on the host, whereby the VHE enables direct invoking by any one application of any another application residing on the PMD through automatic file and link associations, without invoking applications that reside on the Host itself

According to the present invention there is provided a system for enabling host-independent software portability, the system including an active personal mobile device (PMD) having host software that includes a VHE and a plurality of host applications, and a host capable of executing the host software when the host is connected to the PMD, whereby the VHE enables one host application stored on the PMD to invoke another host software stored on the PMD through automatic file and link associations.

According to the present invention there is provided a method for enabling host-independent software portability, the method including steps of providing an active PMD, placing host software on the active PMD, wherein the host software would normally require an installation process on the host. and running the host software on a host when the respective host is connected to the PMD without performing an installation process.

### BRIEF DESCRIPTION OF THE DRAWINGS

For a better understanding of the present invention and to show more clearly how it could be applied, reference will now be made, by way of example only, to the accompanying drawings in which:

FIG. 1 describes the general structure of a system of the present invention;

FIG. 2 describes a method of launching Host software that resides on the Host using parameters and settings which stored on the PMD;

FIG. 3 describes the method of launching general Host software from the PMD;

FIG. 4 describes a method of creating or receiving content on the PMD when it is detached from the Host, and then launching Host software from the PMD which interacts with such content;

FIG. 5 describes a method of receiving content for the PMD from a remote server while the PMD is connected to a Host;

FIG. 6 describes a method of receiving software updates for Host software that resides on the PMD from a remote server while the PMD is connected to a Host;

FIG. 7 describes the Virtual Host Environment created by the Host software that resides on the PMD.

### DETAILED DESCRIPTION OF THE INVENTION

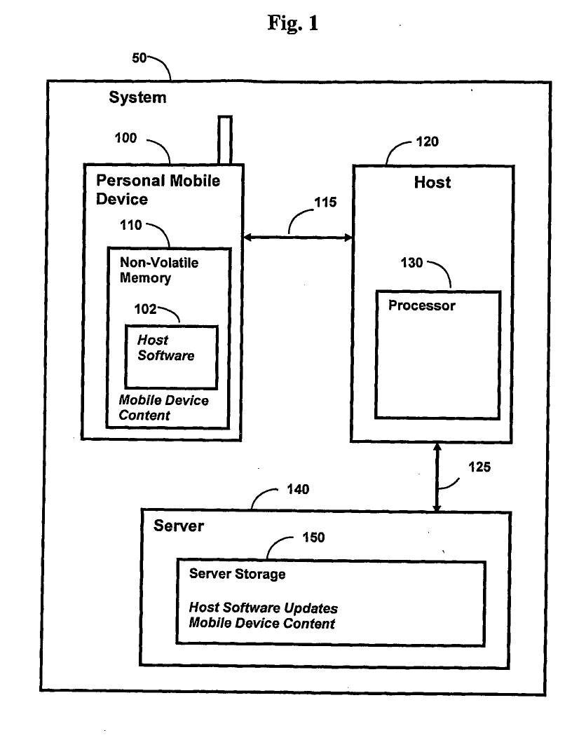

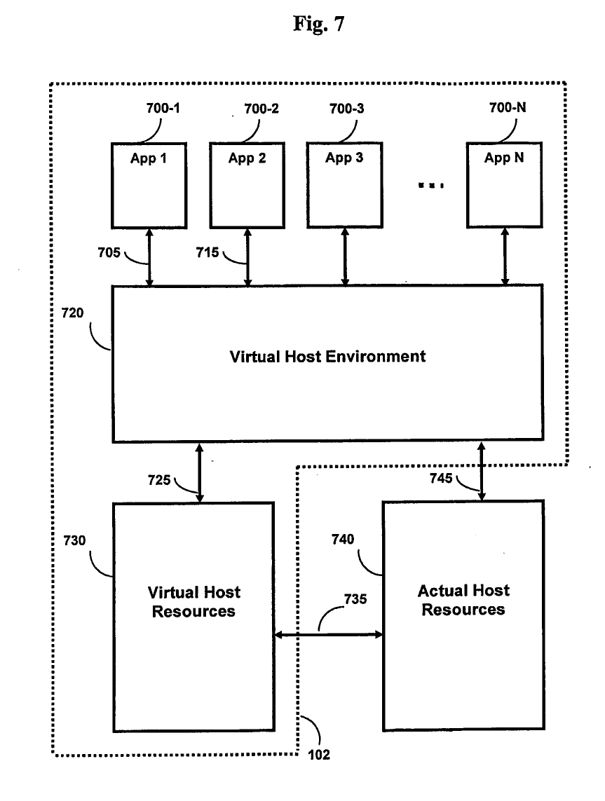

FIG. 1 describes the general structure of a system 50 of the present invention. System 50. comprises an active PMD 100 that includes a non-volatile memory 110 storing a Host software 102, a Host 120 that includes a Host processor 130 and a Server 140 that includes a storage 150, interconnected as shown. Host software 102 is not executed on the PMD. Instead, when PMD 100 is connected to Host 120 through an interface 115, Host software 102 is executed on processor 130 in Host 120. Host software 102 is executed by the Host while still residing in non-volatile memory 110 of the active PMD, without being copied to or installed on a permanent storage on Host 120 (such as a hard disk). The internal structure of Host software 102 is described in more detail in FIG. 7.

Host software 102 is used for interaction of Host 120 with content stored on PMD 100. Such interaction may include transfer of content between Host 120 and PMD 100; editing, storage, organizing and printing of mobile content such as images, video clips and sound clips using Host 120; sending messages (such as SMS, MMS and email) which are edited on Host 120 through PMD 100; and synchronizing the contents of PMD 100 and Host 120, such as address books, tasks, web bookmarks, files, and other user content to enable the user to seamlessly access such data both on PMD 100 and on Host 120.

Host software 102 may also be used for general computing purposes which are not related to PMD 100. Such software may include PC communication software (voice and video over IP, instant messaging, email, etc.); personal information management (calendar, tasks, contacts, etc.), personal productivity software (word processing, spreadsheets, presentation software, etc.), security software (anti virus, anti spyware, Virtual Private Network client, etc.), web browsers, games, or any other PC software.

When Host software 102 is executed on Host processor 130, the software communicates with Server 140 over an interface 125. This communication is used for a number of purposes: to retrieve updates to Host software 102 from Server 140, the updates being transferred to non-volatile memory 110 over interface 115 and executed on Host 120 upon further connection of PMD 100 to Host 120; to browse and download media content (images, animations, music files, video files and any other content which is desirable by the user of PMD 100) from Server 140, the media content being transferred to PMD 100 over interface 115 and stored on non-volatile memory 110; and to upload media content (images, video clips and audio clips which are recorded by the user of PMD 100), the content being stored in non-volatile memory 110 and transferred through interface 115 to Host 120.

Inventively, and in contrast with prior art, the Host software 102 is stored on an active PMD (and not on a portable memory device, which is normally passive). Further inventively, the Host software 102 is launched automatically on any host.

In one embodiment, PMD 100 is a mobile phone. In other embodiments, PMD 100 may be a cordless phone, a PDA, a portable audio player, a portable video player, a digital still image camera, a digital video camera, a personal navigation device, a personal TV device, or any other mobile device that is typically used by consumers for communication, content consumption or content creation.

In one embodiment, non-volatile memory 110 is preferably an internal flash memory used by the PMD for storage of content and computer programs. In other embodiments, non-volatile memory 110 may be a hard disk, a removable flash memory card such as Secure Digital, a Compact Flash, a Memory Stick, a Multi-media card, an xD card, a Disk-on-Key, or any other fixed or removable non-volatile memory format.

In one embodiment, interface 115 is preferably a Universal Serial Bus (USB) interface. In other embodiments, interface 115 may be implemented by a wireless method such as wireless USB, Bluetooth, infrared, wireless LAN, UWB, ZigBee or a proprietary wireless interface, or by a wired method such as Firewire (IEEE-1394), Ethernet, serial cable, parallel cable, or a proprietary wired interface.

In one embodiment, Host 120 is preferably a personal computer. In other embodiments, Host 120 may be an enterprise workstation, a tablet computer, a PDA, a set-top box, a media server, a television set, a car navigation/entertainment system, or any other device that is typically used by consumers for data storage, access, display, input, and manipulation.

In one embodiment, interface 125 is preferably implemented using a DSL modem, which connects Host 120 to an Internet backbone (not shown). In other embodiments, interface 125 may be implemented using a dial-up modem, cable modem, Ethernet, wireless LAN, power line communication, phone line network, WiMax, cellular network, or any other method which enables creating a virtual communication link between Host 120 and Server 140.

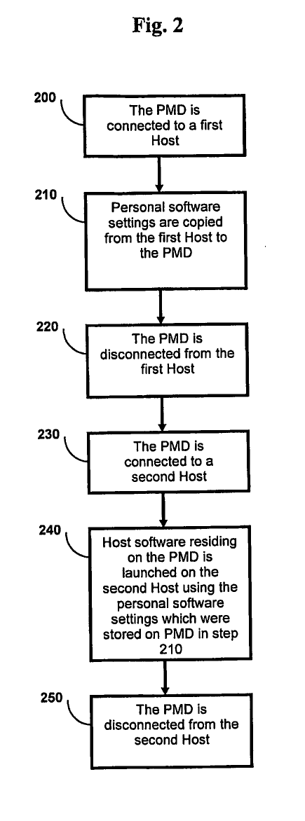

FIG. 2 describes the method of launching Host software residing on a Host using parameters and settings stored on the PMD (“Profiled Applications”).

In step 200, the PMD is connected to a first Host through the standard interface. The first Host may be the user's main PC or any PC from which the user desires to copy his/her personal settings.

In step 210, personal software settings are copied from the first Host to the PMD, and stored in the non-volatile memory of the PMD for later use.

In step 220, the PMD is disconnected from the first Host.

In step 230, the PMD is connected to a second Host through the standard interface. The second Host may be the user's secondary PC, his/her work PC, a public PC in a hotel, university campus, enterprise, etc., or any PC to which the user desires to apply his/her personal settings.

In a particularly inventive step 240, Host software residing on the second Host is launched using the personal software settings stored on PMD in step 210. These settings do not require any installation or configuration of the Host software residing on the second Host.

In yet another inventive step 250, the PMD is disconnected from the second Host. After disconnecting from the second Host, the settings of the second Host are automatically restored to their state before step 240, without leaving any trace of the user settings on the second Host or requiring any action by the user.

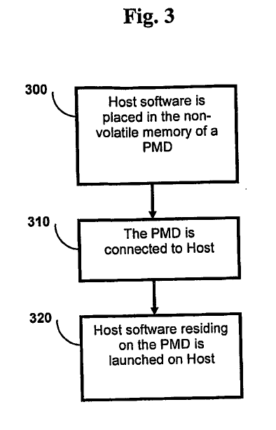

FIG. 3 describes the method of launching a general Host software from the PMD.

In step 300, Host software is placed in the non-volatile memory of a PMD by connecting the PMD to a Host and installing the software on the PMD, by copying files from the Host to the PMD, or by pre-installing the software on the PMD.

In step 310, the PMD is connected to the Host through the standard interface.

In step 320, the Host software residing on PMD is launched on Host, and runs without requiring any installation.

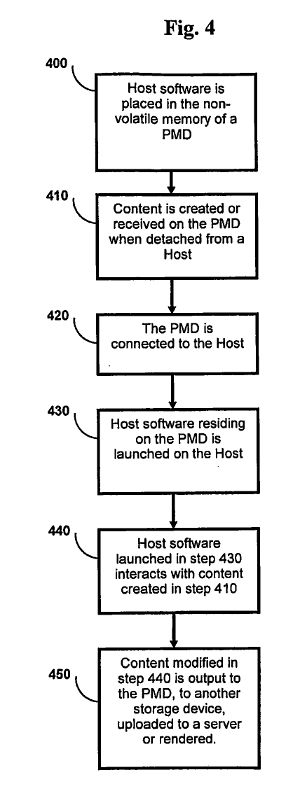

FIG. 4 describes the method of launching Host software from the PMD, where the Host software interacts with content that is created on received on the PMD when it is detached from the Host.

In step 400, the Host software is placed in the non-volatile memory of a PMD by connecting the device to a Host and by installing the software on the PMD, by copying files from the Host to the PMD, or by pre-installing the software on the PMD.

In a particularly inventive step 410, content is created or received on the PMD when the PMD is detached from the Host. Content creation may include capturing content with the PMD's camera, microphone, stylus, keypad or keyboard, or by receiving the content over a wireless connection such as a cellular or wireless LAN network. Note that content creation is simply impossible on prior art passive memory devices.

In step 420, the PMD is connected to the Host through a standard interface such as USB.

In step 430, the Host software residing on PMD is launched on Host, and runs without requiring any installation.

In step 440, the Host software launched in step 430 interacts with the content created or received by the PMD in step 410. Such interaction may include transfer of content between the Host and the PMD; editing, storing, organizing and printing of mobile content such as images, video clips and sound clips using the Host; sending messages (such as SMS, MMS and email) which are edited on the Host, through the PMD; and synchronizing the content of the PMD (such as address books, tasks, web bookmarks, files, and other user content) with the Host device to enable the user to seamlessly access such data both on the PMD and the Host.

In step 450, the content modified in step 440 is output to the PMD or to another storage device, uploaded to a server or rendered. For example, synchronized contacts, calendar, tasks and email are transferred back to the PMD; pictures are stored on the Host, burned to CD/DVD, printed, or uploaded to a server on the Internet; video clips are stored on the Host, burned to CD/DVD or uploaded to a server on the Internet; music files are played on the Host, stored on the Host, burned to CD/DVD or uploaded to a server on the Internet; or SMS and MMS messages edited on the Host are sent back to the PMD for delivery over cellular networks.

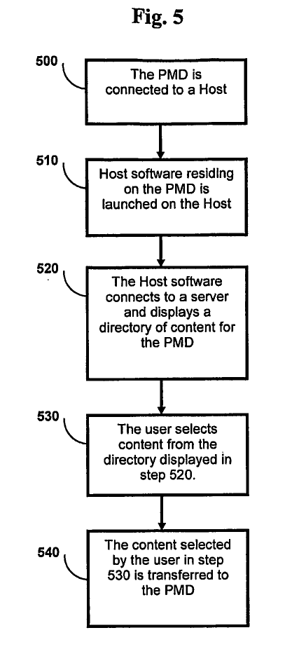

FIG. 5 describes the method of receiving content for the PMD from a remote server while the PMD is connected to the Host.
1) In step 500, the PMD is connected to the Host through a standard interface such as USB.
2) In step 510, the Host software residing on PMD is launched on Host, and runs without requiring any installation.
3) In step 520, the Host software connects to a server residing on the Internet and displays a directory of content which is relevant to the PMD. Such content will vary based on the type of PMD, and may include music tracks, video clips, software applications, games, ring tones, images, screen savers, or any other content that typically resides on the PMD.
4) In step 530, the user selects content from the directory displayed in step 520. Selection is done using the user interface of the Host, which is much easier than using the limited user interface of the PMD.
5) In step 540, the content selected by the user in step 530 is transferred to the PMD. The transfer can occur either over the same interface through which the PMD is connected to the Host (such as a USB) or through another interface or network such as cellular, wireless LAN, etc.

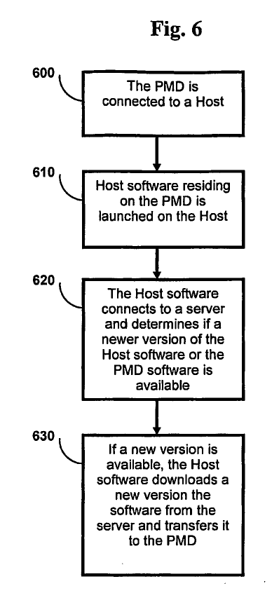

FIG. 6 describes the method of receiving software updates for the Host software residing on the PMD from a remote server while the PMD is connected to the Host.
1) In step 600, the PMD is connected to the Host through a standard interface such as USB.
2) In step 610, the Host software residing on PMD is launched on Host, and runs without requiring any installation.
3) In step 620, the Host software launched in step 610 connects to the server and determines if a newer version of Host software or of PMD software is available for download.
4) In step 630, if a new version of the Host software or Mobile Device Software is available, the Host software downloads the new version of the software from the server to the PMD.

FIG. 7 describes the internal structure of Host software 102, and its interaction with the Host resources to create a Virtual Host Environment (VHE). This environment, which resides on the PMD and is executed on the Host, enables one application residing on the PMD to invoke another application residing on the PMD through automatic file and link associations, without invoking applications that reside on the Host itself. The internal structure of Host software 102 comprises a VHE 720 that resides on the PMD and is executed on the Host, Host applications 700-1 to 700-N that reside on the PMD and are executed on the Host, and Virtual Host Resources (VHR) 730 that reside on the PMD and are accessed by the Host applications through VHE 720. Host software 102 interacts with Actual Host Resources (AHR) 740 that reside on the Host. VHE 720 is centrally managed for all Host applications, including Host applications 700-1 and 700-2. VHR 730 are common to all Host applications, including Host applications 700-1 and 700-2. Therefore, the interaction between all Host applications, including Host applications 700-1 and 700-2, is performed through VHE 720 and uses VHR 730, ensuring that the user of these applications remains within the environment carried on his/her PMD, and does not invoke AHR 140 unless the required resources are not found in VHR 730.

When Host application 700-1 executes through an interface 705 on VHE 720 and asks for a system resource, VHE 720 can refer the resource request either through an interface 725 to VHR 730 or through an interface 745 to AHR 740. Even if the resource is referred to VHE 720, it can eventually be referred to AHR 740 through an interface 735.

VHR 730 includes all resources required by the Host applications, and should be available to the user when connecting the PMD to any Host. Examples of VHR include:
Specific document folders that are common to many applications, such as the folders “My Documents”, “My Music” and “My Pictures” in Microsoft Windows. If Host application 700-1 saves a file to the specific document folders, the file is stored in VHE 730. When Host application 700-2 tries to read files from the specific document folders, the read request is routed by VHE 720 to VHR 730, enabling Host application 700-2 to read the file written by Host application 700-1.
Program files folders: When a Host application 700 is installed, the installation files are routed by VHE 720 to VHR 730, making the Host applications fully portable.
Operating system folder: When Host application 700-1 saves a file to the operating system folder (such as the Windows folder in Microsoft Windows), the file is saved by VHE 720 in VHR 730. When Host application 700-2 tries to load a file from the operating system folder, VHE 720 first redirects the file request to VHR 730, and if the file is not found there, the call is redirected to the actual Host Resources 740.
System settings database: VHR 730 includes a virtual system settings database (Registry in Microsoft Windows). When a Host application 700 tries to write a key to the system settings database, they key is written by VHE 720 to VHR 730. When a Host application 700 tries to read a key from the system settings database, VHE 720 first searches for the key in VHR 730, and if the key does not exist it is loaded from actual Host Resources 740.
   The system described in FIG. 7 enables interaction between Host applications in the VHE, using VHR. Below are some examples of this interaction:
If Host application 700-1 registers itself as being able to process certain file types by registering the file type extensions, it will be invoked when Host application 700-2 tries to open these file types. For example, if Host application 700-1 is an image viewing software which registered the .JPG file format in VHR 730, and Host application 700-2 is an email program, then when the user clicks on a .JPG file attachment to an email message in Host application 700-2, this will cause Host application 700-1 to launch for viewing this JPG file.
If Host application 700-1 registers itself as the default web browser, it will be invoked when Host application 700-2 tries to access a web link. For example, if Host application 700-1 is the default web browser and Host application 700-2 is an email program, then when the user clicks on a web address inside an email message in Host application 700-2, this will cause Host application 700-1 to launch for browsing to that address.
If Host application 700-1 saves documents to the default documents folder (such as “My Documents” in Microsoft Windows), these documents will be available to Host application 700-2 when it opens the default “My Documents” folder, since that folder is a common virtual resource to both applications.

In contrast with U.S. Patent Application 2005/0240918, which refers to a portable memory device, the current invention utilizes a personal mobile device (PMD). A PMD such as a mobile phone is carried anyway by the user, as opposed to a portable memory device that is carried only occasionally. Therefore, the present invention enables better functionality than application 2005/0240918. Another key difference is that a PMD can create and receive content while disconnected from the Host, while a portable memory device cannot. Therefore, placing Host software application on a PMD which interacts with content created by the PMD when disconnected from the Host is an invention which has greater utility than placing general Host software applications on a portable memory device.

Another difference from the prior art is that Host software applications that reside on the portable memory device according to the method described in application 2005/0240918, or as implemented in commercial products on the market by Migo and Thinstall, are independent of each other, and no not form a full virtual working environment on the Host. Virtualization in the prior art is performed separately for each application, and not through a common VHE with common Virtual Host Resources. Therefore, if one application residing on the portable memory device launches a second application, the second application will be launched from the Host and not from the portable memory device. According to the system and methods described in the present invention, if one application launches a second application, the second application will also be launched from the PMD.

In conclusion, the present invention discloses a system and methods that enable placing Host software on an active PMD, and running such software on a Host connected to the PMD, without installing the software on the Host. In this way, the PMD becomes self-contained, and can connect to any Host for the purpose of interaction, manipulation and transfer of the content stored on the PMD, without requiring any proprietary software related to the PMD to be pre-installed on the Host, and without installing any software on the Host during the connection of the PMD to the Host.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A system for enabling host-independent software portability, comprising:
a. a host capable of executing host software; and
b. an active personal mobile device (PMD) capable of creating and receiving content while disconnected from the host and capable of running the host software on the host when connected to the host.

2. The system of claim 1, further comprising:
c. a server operatively coupled to the host and the PMD and capable of storing host software updates and PMD content for use in exchanges with the host and the PMD respectively,
whereby the host software is launched automatically on any host upon connection of the PMD to that host.

3. The system of claim 1, wherein the host includes a host processor for executing the host software.

4. The system of claim 1, wherein the PMD includes a non-volatile memory for storing the host software.

5. The system of claim 2, wherein the server includes a server storage for storing the host software updates and the PMD content.

6. The system of claim 1, wherein the host is a personal computer.

7. The system of claim 1, wherein the host is an entity selected from the group consisting of an enterprise workstation, a tablet computer, a PDA, a set-top box, a media server, a television set and a car navigation/entertainment system.

8. The system of claim 1, wherein the PMD is a mobile phone.

9. The system of claim 1, wherein the PMD is a device selected from the group consisting of a cordless phone, a PDA, a portable audio player, a portable video player, a digital still image camera, a digital video camera, a personal navigation device and a personal TV device.

10. The system of claim 1, wherein the host software includes software selected from the group consisting of personal computer (PC) software, PC communication software, personal information management software, personal productivity software, security software, web browsers and games.

11. The system of claim 1, wherein the non-volatile memory includes a flash memory.

12. The system of claim 1, wherein the non-volatile memory includes a memory selected from the group consisting of a hard disk, a removable flash memory card, a compact flash memory, a memory stick, a multi-media card, an xD card and a disk-on-key.

13. The system of claim 1, wherein the host software includes a virtual host environment (VHE) executable on the host,
whereby the VHE enables direct invoking by any one application of any another application residing on the PMD through automatic file and link associations, without invoking applications that reside on the Host itself.

14. A system for enabling host-independent software portability, comprising:
a. an active personal mobile device (PMD) having host software that includes:
i. a virtual host environment (VHE), and
ii. a plurality of host applications; and
b. a host capable of executing the host software when the host is connected to the PMD,
whereby the VHE enables one host application stored on the PMD to invoke another host software stored on the PMD through automatic file and link associations.

15. The system of claim 14, wherein the PMD further includes virtual host resources (VHR) that interact with the host applications stored on the PMD through the VHE and wherein the host includes actual host resources (AHR) that interact with the host software.

16. A method for enabling host-independent software portability, comprising steps of:
a. providing an active personal mobile device (PMD);
b. placing host software on the active PMD; and
c. running the host software on a host when the respective host is connected to the PMD without performing an installation process on the host.

17. The method of claim 16, wherein the step of placing includes placing installable host software.

18. The method of claim 17, wherein the step of placing includes placing the host software in a non-volatile memory of a PMD using a procedure selected from the group consisting of connecting the PMD to a host and installing the software on the PMD, copying files from a host to the PMD and pre-installing the host software on the PMD.

19. The method of claim 17, wherein the step of running includes connecting the respective host to the PMD and launching the host software on the host.

20. The method of claim 19, wherein the step of providing includes providing an active PMD having content created thereon prior to the connecting of the respective host.

21. The method of claim 19, wherein the step of providing includes providing an active PMD having content received thereon prior to the connecting of the respective host.

22. The method of claim 21, wherein said launching is followed by receiving content for the PMD from a remote server while the PMD is connected to the respective host
